(19) United States
(12) Patent Application Publication
(10) Pub. No.: US 2011/0162242 A1
(43) Pub. Date: Jul. 7, 2011

(54) Bottle, can or container "Boot" that provides temporary or permanent additional information

(76) Inventor: Alex Jay Lindsey, (US)

(21) Appl. No.: 12/655,700

(22) Filed: Jan. 6, 2010

(51) Int. Cl. G09F 3/00

(52) U.S. Cl. 40/306

(57) ABSTRACT

A separate add on label that includes additional information such as product information features, temporary price changes, consumer incentives or comments by satisfied customers, as well as any other information. The information may be printed on any desired material on at least one side surface and includes a part by which the temporary label can be placed onto a container. The add on label should have a size and a shape by which the separate add on label can be placed onto the container without covering the entire container surface as well as the information on the fixed label.

### BACKGROUND OF THE INVENTION

### Field of the Invention

The invention relates to a means for adding an advertisement or any other information onto a previously labeled package or container, more particularly to a previously labeled bottle or can.

It is well known that packaging labels have been secured onto packaged, canned and bottled goods to relate product information regarding the packaged goods or the contents of the packaged goods or the contents of the container. There may be a desire to add specific information of a temporary or permanent nature regarding the product in addition to that which is included on the secured label. The “Add Boot” is an invention directed to a separate formed label to include any additional information regarding the product.

### OBJECT AND SUMMARY OF THE INVENTION

It is therefore an object of the invention to provide a separate label which can be temporarily or permanently placed onto a package, can, bottle or other container type to provide additional information not included on the fixed label.

Another object of the invention is to provide an additional label which can be easily fitted on to and removed from a container.

Other objects and advantages of the invention will become obvious to those skilled in the art upon review of the drawings, specifications and claims.

### BRIEF DESCRIPTION OF THE DRAWINGS

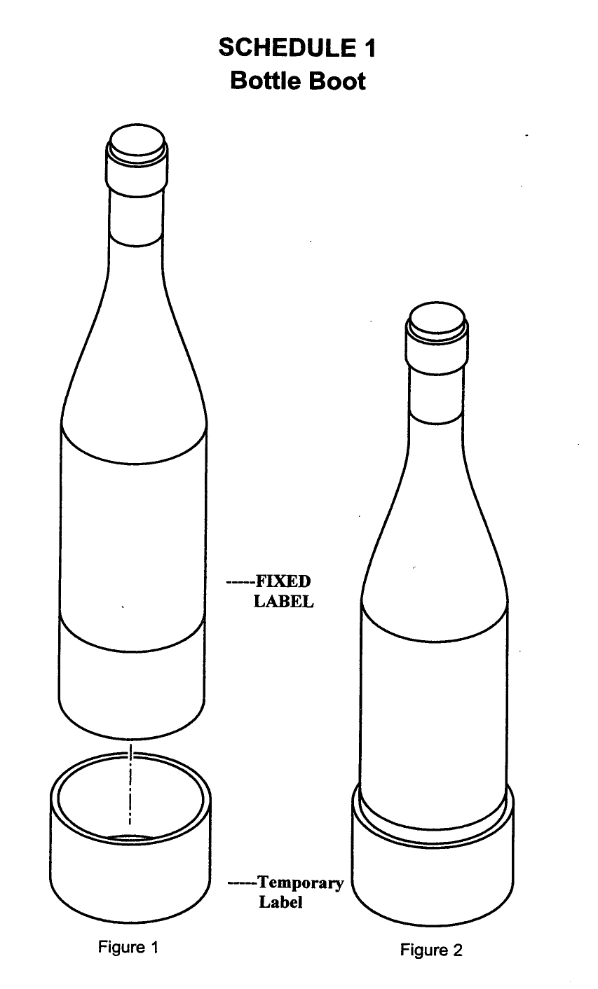

Schedule 1: FIG. 1 illustrates a front view of the bottle with a separate temporary label (boot) shown below the bottle.

Schedule 1: FIG. 2 illustrates the bottle shown in FIG. 1 with the label (the boot) slipped onto the bottom portion of the container (bottle).

### DESCRIPTION OF THE PREFERRED EMBODIMENT

Now, referring to the drawing, in FIG. 1 there is shown a container which can be of any desired shape (in this case a bottle) having a usual fixed label which includes any normal information about the product such as formulation, ingredients, weight, etc. The fixed label is identified by the term “FIXED LABEL”. A separate add on label is shown below and spaced from the bottom of the container (bottle) and coaxial therewith.

The separate add on label is shown formed in cylindrical form with a closed or open bottom end. The separate add on label is just large enough in diameter to slide over the bottom of the container (bottle) and is of the same shape.

FIG. 2 illustrates the container (bottle) with the temporary label slipped onto the bottom portion of the bottle. The bottle is shown with a cylindrical bottom therefore, the temporary label is cylindrical to fit over the bottom of the bottle.

The container (bottle) and the separate add on label could be any other shape as long as the separate add on label is compatible with the container's (bottle's) size and shape.

The drawing illustrates a separate add on label that is cylindrical that provides a temporary label for a bottle or other shaped container. It would become obvious from the specification and drawing that containers with any other shapes can be provided with a separate add on label compatible with the particular shape of that container. The important feature is that the separate add on label would fit over the bottom of the container and that the information on the separate add on label would read from a direction of the upward end of the container downwardly toward the lower end of the container.

The separate add on label is in addition to the fixed labels.

1. A separate add on label having any desired information on at least one side surface for adding additional information to a container having at least one fixed label, and said separate add on label including means for supporting the separate label on said container.

2. A separate add on label as set forth in claim 1, wherein
the separate add on label is cylindrical and is closed on the bottom or the top end for addition to a container having a fixed label.

3. A separate add on label as set forth in claim 1, wherein
The add on label is poly sided as to conform to the container and is closed at the top or the bottom end for addition to a container having a fixed label.
